(19) United States
(12) Patent Application Publication
(10) Pub. No.: US 2007/0138179 A1
(43) Pub. Date: Jun. 21, 2007

(54) Container closure with reservoir for holding a second material

(76) Inventors: Glen Roderick Jacobs, Smithfield (AU); Matthew James O'Connor, Cairns (AU)

Correspondence Address: CANTOR COLBURN, LLP, 55 GRIFFIN ROAD SOUTH, BLOOMFIELD, CT, 06002, US

(21) Appl. No.: 10/552,844

(22) PCT Filed: Apr. 14, 2004
(86) PCT No.: PCT/AU04/00488

§ 371 Date: Jun. 9, 2006

(30) Foreign Application Priority Data
Apr. 14, 2003 (AU) 2003203687

(51) Int. Cl. A47G 19/22; B65D 53/06; B65D 51/16; B67D 3/00

(52) U.S. Cl. 220/254.9; 220/717; 215/388; 222/559; 220/212; 220/521; 215/311; 215/228

(57) ABSTRACT

Container closure (10) engageable with a container having an interior for containing a fluid, water or drink, the container closure adapted to allow mixing of the fluid and a second material. The closure (10) has a movable mouthpiece (12), a fluid opening which is associated with sealing means (28, 29) adapted to substantially seal the fluid opening in a first position and allow fluid to flow in a second position. The closure also has a regulation ring (27) with bulbous portion (30) that can open and close an opening to a reservoir (13) containing the second material. The first fluid and second material are mixed in a passage prior to exiting the container closure.

### FIELD OF THE INVENTION

The present invention relates to containers and closures therefore and in particular to closures for containers allowing the mixing of fluids.

### BACKGROUND ART

Ready to drink products have experienced a vast increase in popularity in recent times. One company selling such products experienced a 40% lift in ready-to-drink (RTD) sales volume in 2001/02, and tipped double-digit volume growth across the RTD market to continue.

The majority of RTD products are pre-mixed drinks. These drinks have a particular percentage by volume of base liquid or “mixer” and the remainder is the active ingredient, usually an alcohol or liquor. Of course, with the rapidly expanding popularity of quick and easy to prepare foods and drinks, many different types of drink are now sold in a ready to drink form such as teas and various weight loss and health drinks.

Various methods and apparatus have been developed in the past to allow for the mixing of fluids in particular drinks. One such device is a compartmented container formed of a can having a single wall and opposite openable ends. The container includes a divider affixed diametrically across the interior of the container, thereby defining two separate volumes within the single can or container. The two volumes share the single divider wall in common. The divider wall is usually formed of the same material, or of material compatible with, the material used to form the remainder of the container, or at least the ends of the container. The divider is preferably formed of a rigid material, and may include ribs or another form of stiffeners extending diametrically thereacross, in order to resist any differential pressures which may develop between the two volumes. This device does not allow the fluids contained to be mixed upon exit from the container but merely a convenient way to transport two fluids which may be mixed together.

Another device which is directed towards mixing of two fluids is a pre-mix beverage dispensing apparatus including an ice bank assembly connected to a remote system of potable water at line pressure for the chilling of the potable water. The chilled water is carried at a regulated line pressure from the ice bank assembly to a mixing valve/dispensing assembly where the chilled water is metered into a prescribed amount and mixed with a proportionate amount of syrup metered from a syrup holding tank. The syrup tank is provided with an agitating element that periodically agitates the syrup to prevent syrup constituents from precipitating out of solution or stratification of the syrup into various concentration levels. As can be appreciated, this device is more suited to a fixed environment due to its size and is not particularly suited to mobile drinking containers.

There are also known methods of packaging and preparing a mixed drink. According to this method, pre-measured mixer ingredients are packaged in a container that is marketed and sold with extra head-space for the subsequent addition and shaking of ingredients according to the consumer's taste. The container may include a strainer for straining the mixed drink prior to serving. The consumer prepares the drink by adding an alcoholic beverage and, if desired, ice through the wide opening of the container. Blending of the ingredients may be accomplished by shaking the container, which is provided with a removable, leak-proof cap. The ingredients may be strained through the detachable strainer when they are poured from the container, or the container itself may be used as a drinking vessel, thus minimizing the time, effort, and inconvenience of amassing a variety of containers and implements that are associated with prior art methods of packaging the ingredients for mixed drinks and preparing mixed drinks. This container allows the addition of extra ingredients. The extra ingredients must be transported separately and simply poured into the container when required.

It can be seen from the above devices that none provide a portable, simple to use container closure allowing the simultaneous mixing and dispensing of fluids.

It will be clearly understood that, if a prior art publication is referred to herein, this reference does not constitute an admission that the publication forms part of the common general knowledge in the art in Australia or in any other country.

### SUMMARY OF THE INVENTION

The present invention is directed to a container closure, which may at least partially overcome the abovementioned disadvantages or provide the consumer with a useful or commercial choice.

In one form, the invention resides in a container closure engageable with a container having an interior for containing a fluid, the container closure adapted to allow mixing of the fluid and a second material, the container closure comprising a fluid opening through which fluid can flow, the fluid opening in fluid communication with the interior of the container, the fluid opening associated with sealing means adapted to substantially seal the fluid opening in a first position and allow fluid to flow in a second position, a reservoir containing a second material, a first dispenser member associated with the reservoir and having at least one dispenser opening therein, and a second dispenser member respectively formed in relation to the first dispenser member, the second dispenser member movable between a closed position wherein the at least one dispenser opening in the first dispenser member is substantially obstructed so that no second material can flow, and at least one open position wherein the at least one dispenser opening in the first dispenser member is at least partially unobstructed so that the second material can flow and mix with the fluid flowing from the container.

It is preferred that the second material is capable of flow whether fluid, liquid or particulate, and in a particularly preferred embodiment the second material will be a second fluid. The second material or second fluid may be fully or partially miscible or immiscible with the first fluid. The container closure may be adapted to allow mixing of the fluid contained in the container and a second material or fluid. In instances where the container closure is adapted to mix two fluids, they may be a first fluid and a second fluid.

The container closure may preferably be engageable with the container holding the first fluid in any way. Most preferably, the container closure will have a threaded portion, whether internally or externally threaded, which may be adapted to engage with a threaded portion on the container. In this way, the container closure will preferably act as a “screw-top”.

The container closure may preferably be at least partially see-through. In a particularly preferred embodiment, the container closure may only be see-through in the region of the reservoir containing the second material, in order to ascertain the amount of second material remaining in the reservoir.

The container closure may typically form a fluid type seal with the container. The fluid type seal maybe enhanced by the use of sealing means such as a rubber washer or the like interposed between the container closure and the container. The container closure may have a grip enhancing means on an outer portion to allow users to attach and detach the container closure from the container holding the first fluid. The grip enhancing means may suitably be adapted for manual operation.

The container holding the first fluid may suitably be of any shape, but is preferably substantially cylindrical. Suitably, the most important feature that the container should possess is an opening adapted to engage with the container closure. The fluid held in the container may be any type of fluid but particularly may be a liquid.

The container closure may suitably be manufactured from a strong but light material, for example plastic. Most preferably, the container closure may be manufactured from polyethylene terephthalate (PET). The container closure may suitably be injection moulded but may be manufactured according to any appropriate method.

In a particularly preferred embodiment, the container closure may be equipped with a safety seal. The safety seal may be broken, and therefore allow fluid to flow upon the complete connection of the container closure to the container.

The mixing of the two fluids may preferably occur under gravity that is when the container and the attached container closure are inverted so the container closure is oriented with the fluid opening downward. Alternatively, the mixing of the two fluids may occur when a force is applied to the container, that is by squeezing or other method. In this case, due to the fluid type seal formed between the container closure and the container, squeezing the container increases the pressure inside the container and the container closure thereby forcing the first fluid to flow towards the fluid opening.

The two fluids may preferably mix in a turbulent manner and the mixing may be substantially instantaneous. The mixing may suitably take place according to the desires of the user, enacted by inverting or squeezing the container, for example. It is particularly preferred that the mixing between the two fluids take place with little or no chance of back flow of the mixed fluid or the second fluid into the container holding the first fluid. This aspect may minimise the chance of mixing of the two fluids when no mixing is desired. Means for preventing backflow may be provided.

Suitably, the container closure may be capable of allowing the first fluid in the container access to the fluid opening without mixing with the second fluid. In this way, if the user desires the first fluid alone, the container closure may be adapted to allow this. In a particularly preferred embodiment, the sealing means may comprise a plurality of overlapping flexible flaps or petals. The sealing means may preferably be adapted to open and close the petals according to the desires of the user.

The petals may suitably overlap each other such that in the first or closed position, no fluid from the container can pass through the fluid opening. The petals may be formed to provide an element of mixing due to the flow of fluid past the petals, when the petals are in the second or open position. In a most preferred embodiment, the petals are biased into the closed position. Applying a positive pressure to the container by squeezing or inverting the container, forces the petals into the open position and removing that pressure allows them to close again. This may act to prevent back mixing.

In a particularly preferred embodiment, the sealing means may comprise two action portions, the first action portion positioned above the petals and the second action portion positioned below the petals. Both action portions may suitably have an opening therein, the openings being coaxial. As the sealing means is raised and lowered, the first and second action portions may act to open and close the petals and maintain the petals in the open or closed position as desired by the user.

It is particularly preferred that the first liquid held in the container may be a base liquid and the second material may be a concentrated liquid.

The fluid opening through which fluid can flow may suitably be in an easily accessible portion of the container closure. For example, in order to allow a person to locate the fluid opening adjacent their mouth, the fluid opening may be located at one end of an elongate portion or mouthpiece. A conventional “pop-top” seal may be used. This type of seal may allow fluid to flow when the pop-top is in the raised position and prevent fluid from flowing when the pop-top is depressed. When the pop-top is depressed, the fluid opening may preferably be substantially fluid tight or sealed by the petals.

The pop-top may suitably be operable between the raised position and the depressed position independently of the operation and adjusting of the mixing action and/or the movement of the dispensing portions.

The fluid opening may preferably be annular in cross-section. The fluid opening may be formed by a central extension extending at least partially into an annular cap portion. The fluid opening is preferably in fluid communication with a channel extending through the container closure and linking the fluid opening with the interior of the container holding the first fluid. The channel may preferably be substantially centrally located through the container closure.

The reservoir contains the second material, which is most preferably a second fluid. A single filled reservoir may be capable of mixing with more than the amount of first fluid contained in a container. The reservoir may typically be integrally formed with the container closure. The reservoir may preferably be at least partially see-through in order to ascertain the amount of second material remaining in the reservoir. The reservoir may also be refillable and/or drainable. The reservoir may suitably be designed to drain efficiently and/or easily whether into the first fluid when mixing or simply to empty the reservoir. The reservoir may be removable from the container closure and replaceable.

The reservoir may be formed in a manner that is aesthetically pleasing to a user. For example, the reservoir may be provided with a curved or arcuate profile. The curved or arcuate profile may also provide fewer sharp edges or corners that can cause damage or injury.

The reservoir may also be formed with grip enhancing features to enhance the purchase which may be gained on the reservoir. As the reservoir may be one of the outermost components of the container closure, it is anticipated that a user will grip the reservoir in order to attach the container closure securely to the container and/or break the safety seal.

The reservoir may suitably be manufactured from the same or a similar material to the other components in the container closure or container, or alternatively may be manufactured from a different material.

The reservoir may suitably have at least one opening associated with the first dispenser member.

The first dispenser member may preferably be frustoconical in shape having a larger diameter end and a smaller diameter end. The first fluid may preferably flow through the first dispensing portion from the larger diameter end to the smaller diameter end. The first dispenser member may suitably have an inner wall and an outer frustoconical wall linked at the smaller diameter end. The inner and outer frustoconical walls may be linked at the larger diameter end but they also may not be. The inner wall of the first dispenser member may form part of the channel extending through the container closure and suitably the first fluid flows inside the inner wall. The outer frustoconical wall may preferably be positioned concentrically and coaxially with the inner wall.

In a particularly preferred embodiment, the first dispenser member may be a substantially cylindrical body member having at least one dispenser opening located in a sidewall thereof. The second material may then flow through the at least one dispenser opening into the container closure fluid opening. The first dispenser member may have an inner and an outer sidewall linked at a lower end thereof. Preferably there may be dispenser openings in both the inner and outer sidewall. The sealing means may be provided with at least one extension portion adapted to extend between the inner and outer sidewall of the first dispenser member. When the sealing means is in the first or closed position, the extension portion may be in position between the inner and outer sidewall of the first dispenser member thereby obstructing or closing the openings therein and preventing the second material from flowing. When the sealing means is in the second or open position, the extension portion may be removed from between the inner and outer sidewalls of the first dispenser member, thereby allowing the second material to flow.

Suitably there may be a plurality of dispenser openings in the first dispenser member, the dispenser openings associated with openings in the reservoir. Preferably be dispenser openings may be spaced about the curved surface of the inner and/or outer wall of the first dispenser member toward the lower end of the first dispenser member. As the first dispenser member is in fluid connection with the reservoir containing the second fluid, the second fluid may preferably pass between the inner and outer walls and flow through the dispenser openings. The dispenser openings may suitably be arrayed in a spiral or helical pattern on the inner and/or outer wall. Alternatively they may be arranged in another pattern for example geometrically.

As stated above, the first fluid typically flows through the container closure inside the inner wall of the first dispenser member and the second fluid flows through or between the inner and outer walls of the first dispenser member. The reservoir may preferably be in fluid connection with the first dispenser member at the lower end of the first dispenser member, allowing the second material disposed within the reservoir to flow between the inner and outer walls of the first dispenser member.

The second dispenser member may also preferably be frustoconical in shape having a larger diameter end and a smaller diameter end, when the first dispenser member is frustoconical in shape. Alternatively, when the first dispenser member is cylindrical in shape, the second dispenser member may preferably be cylindrical in shape also. The second dispenser member may be located concentrically and coaxially with the outer wall of the first dispenser member. The second dispenser member may preferably comprise a single wall with an inside surface and an outside surface. The inside surface of the second dispenser member may preferably be respectively formed in relation to the outer wall of the first dispenser member to form a sealing wall to seal the openings in the outer wall of the first dispenser member.

In a particularly preferred form, the second dispenser member may preferably comprise a ring portion with a substantially S-shaped cross section. An inner area of the ring portion may be formed as a sealing wall to seal against the outer wall of the first dispenser member. At a lower end of the sealing wall, the ring portion may be provided with a bulbous portion, the bulbous portion capable of sealing the opening of the reservoir when the second dispenser member is in the closed position.

The second dispenser member may suitably be adapted to move along the length of the first dispenser member. The inside surface of the second dispenser member may be adapted to abut and seal against the outer wall of the first dispenser member when in the closed position and therein substantially obstructing the dispenser openings. Obstructing the dispenser openings may preferably prevent the second material to mix with the first fluid. The second dispenser member may also have the retained in the open position but with the sealing means in the closed position, thereby retaining the setting or mixture strength of the second dispenser member, while not allowing the fluid to mixed with the second material, or allow the fluid to exit the container.

There may suitably be a plurality of the open positions and adjusting between them allows more or less of the second material to flow. There may suitably be at least three open positions, the first open position allowing a small amount of second material to mix with the first fluid, the second open position allowing proportionally more second material to mix with the first fluid, and the third open position allowing the second material to mix with the first fluid restrained only by the size of the dispenser openings. The provision of the plurality of open positions allows a user to adjust the concentration of the second material in the fluid exiting the container closure.

In one preferable configuration, the first dispenser member and the second dispenser member may suitably be rotatively movable with respect to each other between the at least one open and the closed position. According to this configuration, the dispenser openings may be arrayed on the first dispenser member such that they may be uncovered by the rotation of the second dispenser member using a means for moving and fixing the second dispenser member between the closed position and any of the open positions provided. The second dispenser member may be suitably provided with a shaped portion or opening therein in order to incrementally reveal more or fewer of the dispenser openings through manipulation of the means for moving and fixing the second dispenser member between the closed position and any of the open positions provided.

The container closure may suitably further comprise a means for moving and fixing the second dispenser member between the closed position and any of the open positions provided. This means may preferably be called a regulation ring. This means may preferably include a manual adjustment mechanism which may be directly attached to the second dispenser member. The means for moving and fixing the second dispenser member into any of the open positions provided may allow movement between preset positions or a screw thread mechanism movable to provide a multitude of positions and fine adjustment of the amount of second material mixing with the first fluid. The means for moving and fixing the second dispenser member in position may be movable by a user's hand or fingers.

As stated above, the container closure may preferably allow a user to mix the second material with the first fluid on demand or in an as-used basis. There may suitably be no back flow of mixed fluid into the container holding the first fluid.

According to a particularly preferred embodiment, the container and closure design may incorporate a gravity feed system for the second material that can be mixed with the first liquid on demand by adjusting the regulation ring to an open position, and then inverting the container.

The user may regulate the strengths of the mixture by twisting the regulation ring located on an outer portion of the second dispenser member located just below the fluid opening or mouthpiece. The regulation ring is connected to the second dispenser member and when twisted in a counter clockwise direction by the user reveals the dispenser openings on the first dispenser member. The dispenser openings are arranged in a spiral formation which allows the second material to mix in three defined increments (weak, medium and strong) with the first fluid as the container is inverted.

The mixture of the first fluid and the second material then travels a short distance to the fluid opening or mouthpiece which may be a standard pop-top design. The container closure is adapted to allow access to the first fluid only without any contamination or mixing with the second material if such is required by the user. This may be due to the pop-top and regulation ring being separate and independently operable, with one not affecting the function of the other.

The container closure may be adapted to engage with numerous container sizes and configurations. The container closure may prove most beneficial in a wide variety of applications including, but not limited to reusable water bottles with flavouring for children's school lunch refreshments, the health-conscious consumer utilising health supplements and items, combining water and fruit juices, mixed alcoholic beverages and for athletes who would benefit by being able to alternate between both water and sports drinks for hydration during times of intense training. The system may also be adaptable for use with bicycle-mounted water bottles and systems such as the “Camelback” hydration system.

The construction of the container closure is of moulded plastic. It features windows around an upper portion of the reservoir to allow the user to see the amount of second material remaining.

The sealing means and the first and second dispenser members are suitably operable independently of one another. This may suitably allow a user to access the first fluid without accessing the second material or a mixture of the two.

### BRIEF DESCRIPTION OF THE DRAWINGS

Various embodiments of the invention will be described with reference to the following drawings, in which:

FIG. 1 is a side elevation of the container closure according to an aspect of the present invention. The closure is illustrated in the closed position with the reservoir removed.

FIG. 2 is a side elevation of the container closure according to an aspect of the present invention. The closure is illustrated in the open position with the reservoir removed.

FIG. 3 is a detailed schematic view of the flow patterns through the container closure according to an aspect of the present invention. The reservoir and regulation ring are not shown.

FIG. 4 is a detailed schematic view of the flow patterns through the first and second dispenser members according to an aspect of the present invention.

FIG. 5 is a cross-sectional schematic view of the flow patterns through the container closure according to an aspect of the present invention. The container closure is shown in the fully open position.

FIG. 6 is a cross-sectional schematic view of the flow patterns through the container closure according to an aspect of the present invention. The container closure is shown with the mixture setting remaining after the mouthpiece is closed.

FIG. 7 is a cross-sectional schematic view of the flow patterns through the container closure according to an aspect of the present invention. The container closure is shown in the fully closed position.

FIG. 8 is a cross-sectional schematic view of the flow patterns through the container closure according to an aspect of the present invention. The container closure is shown in the retrieval of the fluid in the container only position.

### DETAILED DESCRIPTION OF THE INVENTION

According to an aspect of the present invention, a container closure is provided.

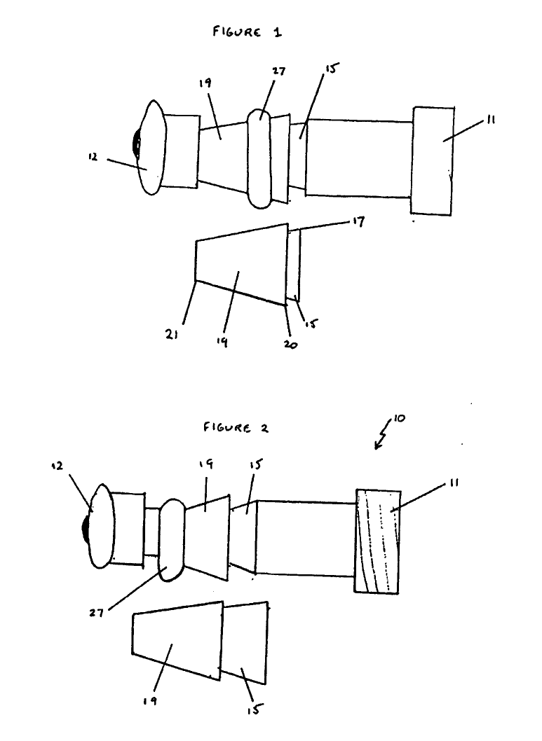

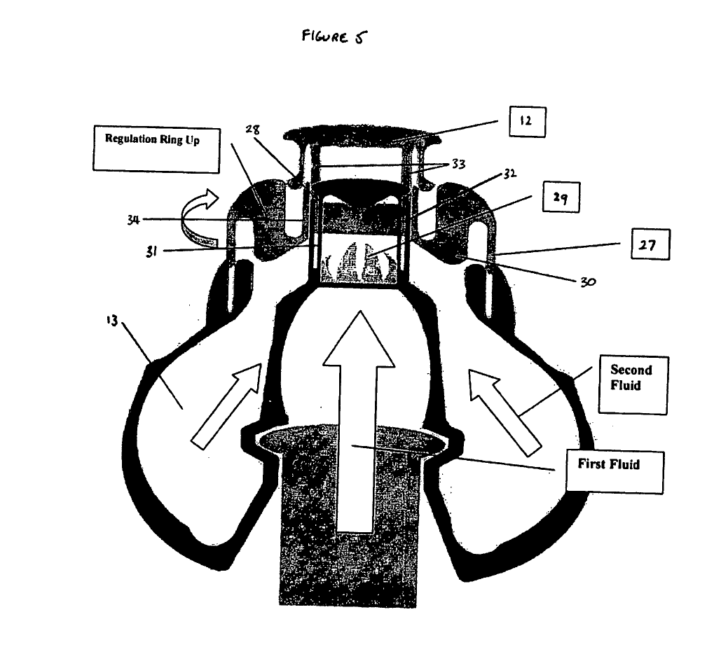

A first preferred configuration of the invention is illustrated in FIGS. 1 to 4.

As seen in FIG. 1, the container closure 10 is adapted to engage with a container having an interior for containing a first fluid and to allow mixing of the first fluid and a second material. The container closure 10 has a means for attachment to the container in the form of a threaded portion.

The threaded portion 11 illustrated is externally threaded and is adapted to engage with a similar threaded portion on the container. In this way, the container closure 10 acts as a “screw-top” for the container.

The container closure 10 forms a fluid type seal with the container. The container closure 10 has a safety seal (not shown). The safety seal is broken, and therefore allow fluid to flow, upon the complete connection of the container closure 10 to the container.

The container closure 10, as illustrated in the Figures, is adapted to allow mixing of the first fluid contained in the container and a second fluid. The mixing of the two fluids may occur under gravity, when the container and the attached container closure are inverted so the container closure is directed downwardly or the mixing of the two fluids may occur when the container is squeezed. Squeezing the container increases the pressure inside the container and the closure thereby forcing the first fluid to flow towards the fluid opening.

The fluid opening through which fluid can flow to the user is shown as a mouthpiece 12. The fluid opening is in fluid communication with the interior of the container.

The mouthpiece 12 is easily accessible to allow a person to locate the fluid opening adjacent their mouth and the fluid opening is located at one end of an elongate portion. A conventional “pop-top” seal is used. This type seal allows fluid to flow when the pop-top is in the raised position and fluid cannot flow when the pop-top is depressed.

The pop-top is operable between the raised position and the depressed position independently of the mixing action and dispensing portions.

A reservoir 13 containing a second material is provided. The reservoir 13 contains the second material, which, in the case of the illustrated embodiment, is a second fluid. The reservoir 13 is integrally formed with the container closure 10. The reservoir 13 is at least partially see-through in order to ascertain the amount of second material remaining in the reservoir 13. The reservoir 13 is also refillable and/or drainable. The reservoir 13 is designed to drain efficiently and/or easily whether into the first fluid when mixing or simply to empty the reservoir 13.

As the reservoir 13 is one of the outermost components of the container closure, it is anticipated that a user will grip the reservoir 13 in order to attach the container closure 10 to the container. The reservoir 13 therefore has grip enhancing features in the form of enlarged portions 14 to enhance the purchase which may be gained on the reservoir 13.

A first dispenser member 15 having at least one dispenser opening 16 therein is shown. The first dispenser member 15 is in fluid connection with the reservoir 13 containing the second material.

The first dispenser member 15 is frustoconical in shape having a larger diameter end 17 and a smaller diameter end 18. The first fluid flows through the first dispensing portion 15 from the larger diameter end 17 to the smaller diameter end 18 in the direction of the arrow. The first dispenser member 15 has an inner wall 22 and an outer frustoconical wall 23 linked at the smaller diameter end 18. The inner wall 22 of the first dispenser member 15 forms part of a channel extending through the container closure 10 and the first fluid flows inside the inner wall 22. The outer frustoconical wall 23 is positioned concentrically and coaxially with the inner wall 22.

There is a plurality of dispenser openings 16 in the first dispenser member 15. The openings 16 are spaced about the curved surface of the outer frustoconical wall 23 of the first dispenser member 15. As the first dispenser member 15 is in fluid connection with the reservoir 13 containing the second fluid, the second fluid can pass between the inner wall 22 and outer frustoconical wall 23 and flow through the dispenser openings 16. The dispenser openings 16 are generally arrayed in a spiral pattern on the outer frustoconical wall 23.

As stated above, the first fluid flows through the container closure 10 inside the inner wall 22 of the first dispenser member 15 and the second fluid flows between the inner wall 22 and outer frustoconical wall 23 of the first dispenser member 15. The reservoir 13 is in fluid connection with the first dispenser member 15 at the larger diameter end 17, allowing the second material disposed within the reservoir 13 to flow between the inner wall 22 and outer frustoconical wall 23 of the first dispenser member 15.

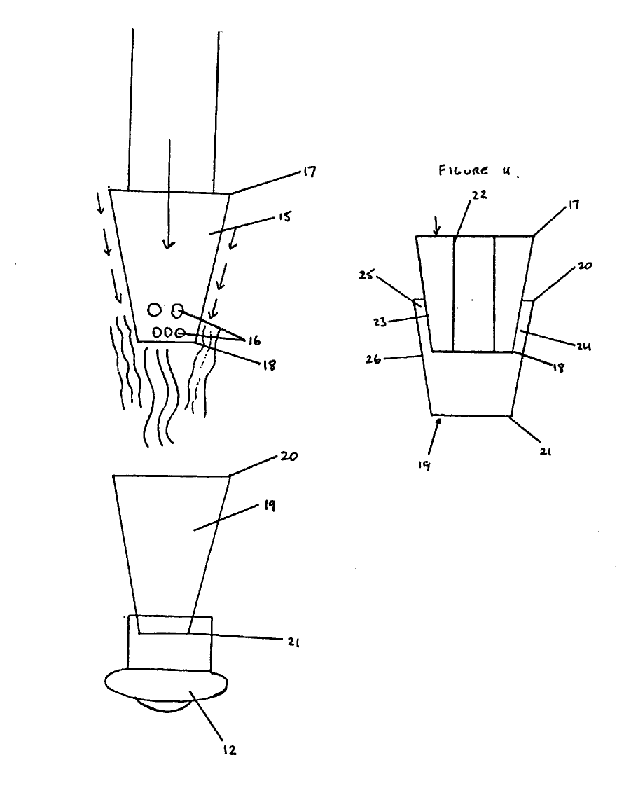

A second dispenser member 19 respectively formed in relation to the first dispenser member 15 is provided. The second dispenser member 19 is movable between a closed position wherein the dispenser openings 16 in the first dispenser member 15 are obstructed so that no second material can flow, as seen in FIG. 1 and at least one open position wherein the dispenser openings 16 in the first dispenser member 15 are at least partially unobstructed so that the second material can flow and mix with the first fluid flowing from the container, as seen in FIG. 2.

The second dispenser member 19 is also frustoconical in shape having a larger diameter end 20 and a smaller diameter end 21. The second dispenser member 19 is located concentrically and coaxially with the outer frustoconical wall 23 of the first dispenser member 15. The second dispenser member 19 has a single frustoconical wall 24 with an inside surface 25 and an outside surface 26. The inside surface 25 of the second dispenser member 19 is respectively formed in relation to the outer frustoconical wall 23 of the first dispenser member 1S.

The second dispenser member 19 is adapted to move along or about the length of the first dispenser member 15. The inside surface 25 of the second dispenser member 19 can abut and seal against the outer frustoconical wall 23 of the first dispenser member 15 when in the closed position and therefore substantially obstruct the dispenser openings 16.

The container closure 10 further comprises a means for moving and fixing the second dispenser member between the closed position and any of the open positions provided called a regulation ring 27. The regulation ring is a manual adjustment mechanism which is directly attached to the second dispenser member. The regulation ring 27 may allow movement between preset positions or a screw thread mechanism movable to provide a multitude of positions and fine adjustment of the amount of second material mixing with the first fluid.

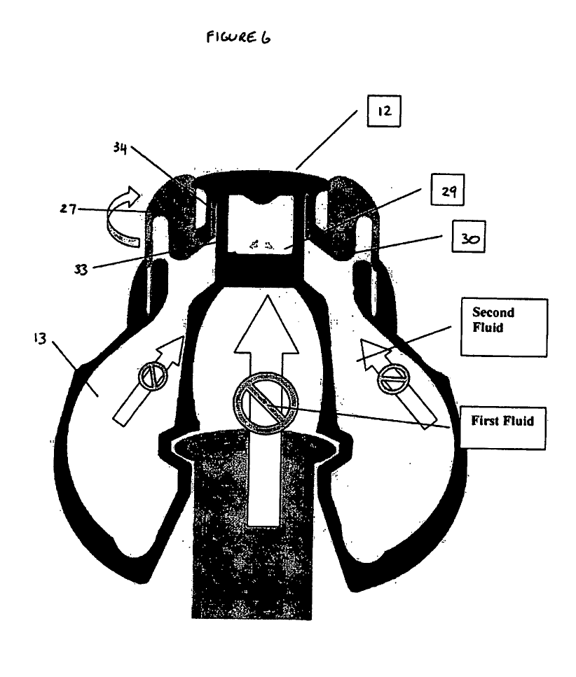

A second preferred embodiment of the invention is illustrated in FIGS. 5 to 8. According to this embodiment, there are three main portions used to control the flow and mixture of the fluids. The three main portions are a mouthpiece 12 having sealing means 28 at one end, mixture petals 29 and a mixture cone/regulation ring 27.

The main function of the container closure according to this embodiment deals with the mixture petals 29. The petals are moved between the open and closed positions using the sealing means 28. Due to their flexibility, these petals 29 flex upwards as the liquid (first fluid by itself or as a combination of both first and second fluids) moves towards the mouthpiece 12. The petals 29 act to mix both fluids together when the container is tipped towards the user's mouth, combining the two liquids to the desired taste depending on the setting at which the regulation ring 27 is set.

The mixture petals 28 cause any remaining liquid (combination of both fluids) to dissipate minimally and equally when the container is tipped back into an upright, resting position. This will allow the user to access the first fluid with little or no contamination from the second material. If any back mixing does occur, it is very slight.

The first dispenser member 15 is a substantially cylindrical body member having at least one dispenser opening 16 located in a sidewall thereof. The first dispenser member has an inner sidewall 31 and an outer sidewall 32 linked at a lower end thereof. There are dispenser openings in both the inner 31 and outer sidewall 32.

The sealing means 28 is provided with at least one extension portion 33 adapted to extend between the inner 31 and outer sidewall 32 of the first dispenser member 15. When the sealing means 28 is in the first or closed position, the extension portion 33 is in position between the inner 31 and outer sidewall 32 of the first dispenser member 15 thereby obstructing or closing the openings 16 therein and preventing the second material from flowing. When the sealing means is in the second or open position, the extension portion 33 is removed from between the inner 31 and outer sidewalls 32 of the first dispenser member 15, thereby allowing the second material to flow.

The second dispenser member 19 comprises a ring portion with a substantially S-shaped cross section. An inner area of the ring portion is a sealing wall 34 to seal against the outer wall 32 of the first dispenser member 15. At a lower end of the sealing wall 34, the ring portion is provided with a bulbous portion 30, the bulbous portion 30 capable of sealing the opening of the reservoir 13 when the second dispenser member 19 is in the closed position.

The second dispenser member 19 is adapted to move along the length of the first dispenser member 15. The sealing wall 34 of the second dispenser member 19 is adapted to abut and seal against the outer wall 32 of the first dispenser member 15 when in the closed position and therein substantially obstructing the dispenser openings 16. Obstructing the dispenser openings 16 prevents the second material mixing with the first fluid. The second dispenser member 19 can also be retained in the open position but with the sealing means 28 in the closed position, thereby retaining the setting or mixture strength of the second dispenser member 19, while not allowing the fluid to mixed with the second material, or allow the fluid to exit the container.

FIG. 5 shows the container closure in its full use configuration. The regulation ring 27 has been twisted in an upward position, allowing the second fluid to be mixed with the first fluid when the container is tipped upright. The mixture petals 29 cause the liquids to combine thoroughly before exiting through the mouthpiece 12. If the user desired to drink solely the first fluid, a simple twist of the regulation ring 27 forces the bulbous portion 30 of the regulation ring 27 to occlude the opening to the reservoir and prevent the second fluid flowing.

As seen in this Figure, the mouthpiece 12 is in the open position, and the mixture petals 29 are also in the open position. The mixture cone/regulation ring is in the fully open position allowing the second fluid to flow over the mixture petals and into the flow path of the first liquid. The mixture petals 29 provide some additional agitation to further enhance the quality of mixing of the two fluids.

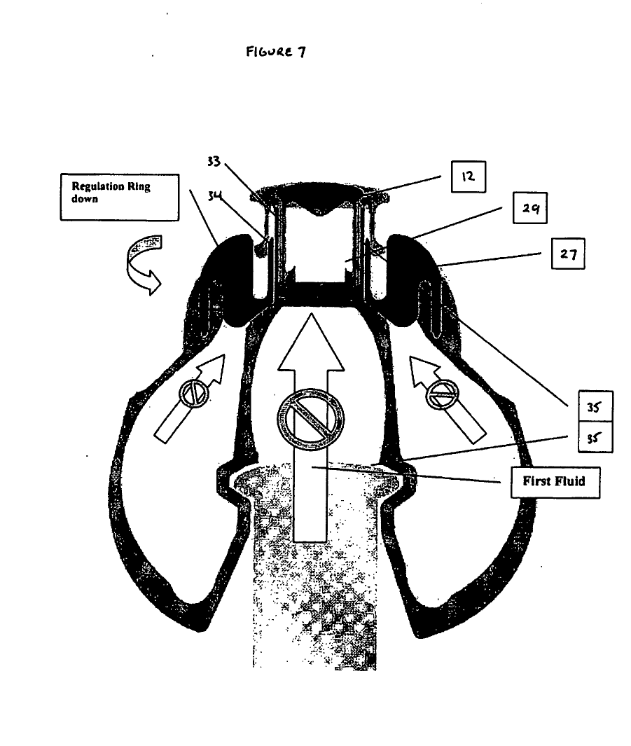

The container closure is illustrated in FIG. 6 in the closed position wherein no fluid (either first or second fluid) can flow. The regulation ring 27 has not moved however in order to maintain the mixture setting desired by the user. When a user requires the container closure to be closed to stop spillage but still wants to keep the regulation ring 27 open at the desired setting without having to constantly reselect that setting, the construction of the device allows the mouthpiece 12 (‘pop-top’ style) to shut off the opening to the reservoir 13. This also alleviates any spillage resulting from the bottle being tipped over. Both the first and second fluids are secure in their respective areas and free from combining, even though the regulation ring 27 is retained in the open position open.

If the mouthpiece 12 did not shut off the flow from the regulation ring 27, inconvenience would ensue due to a possible contamination of the first fluid by the second fluid, for example if the container was knocked over or not left to rest in an upright position. As the mouthpiece 12 is closed, the mixture petals 29 are pressured to seal closed. The mixture cone/regulation ring 27 is still in the fully open position.

The petals 29 are also sealed by the sealing means 28 when the mouthpiece 12 is closed. This prevents the first fluid from flowing.

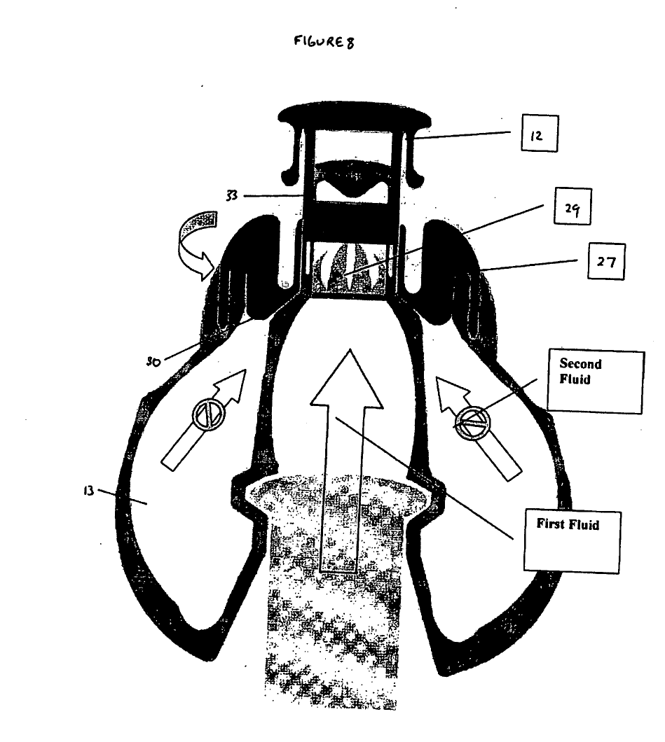

FIG. 7 illustrates the container closure in the fully closed position such as may be found when the container and closure are first sold. Both the regulation ring 27 and mouthpiece 12 are closed. After purchase, the user is free to screw the container closure on any flavour or brand of container he/she desires, to either drink the second fluid mixed with the first fluid or to adjust back and forth between mixed drink and standard bottled liquid with ease and convenience.

The packaged product also has tamper proof seals in place on both the mouthpiece 12 and on the underside of the container closure when purchased, if it is not sold already connected to a container.

In this Figure, the mouthpiece 12 is closed, and the mixture petals 29 are also closed. There are also safety seals 35 provided to ensure the security of the fluids and the device prior to sale. The seals are activated when the container closure is fully attached to the container.

FIG. 8 shows the container closure with only the mouthpiece 12 open. This allows the user to use the device like any other ‘pop-top’ style bottle cap with the added bonus of being able to adjust the mixture to a combined drink and back again by the twist of the regulation ring 27 at any time. The petals 29 are open but the protrusion of the bulbous portion 30 of the second dispenser member 19 into the opening in the reservoir 13 prevents any of the second liquid from mixing with the first liquid.

As stated above, the container closure 10 allows a user to mix of the second material with the first fluid on demand or on an as-used basis. There is no backflow of mixed fluid into the container holding the first fluid.

The operation of the container closure 10 incorporates a gravity feed system for the second material that can be mixed with the first liquid on demand by moving the regulation ring 27 to the open position, and then inverting the container.

The user regulates the strength of the mixture by twisting the regulation ring 27 located on an outer portion of the second dispenser member 19 located just below the fluid opening or mouthpiece 12. The regulation ring 27 is associated with the second dispenser member 19 and when twisted in a counter clockwise direction by the user reveals the dispenser openings 16 on the first dispenser member 15. The dispenser openings 16 are arranged in a spiral formation which allows the second material to mix in three defined increments (weak, medium and strong) as the first fluid as the container is inverted.

The mixture of the first fluid and the second material then travels a short distance to the fluid opening or mouthpiece 12 which is a standard pop-top design. The container closure 10 is adapted to allow access to the first fluid only if such is required by the user, without any contamination or mixing with the second material. The pop-top and regulation ring 27 are separate and independently operable, with one not affecting the function of the other.

In the present specification and claims, the word “comprising” and its derivatives including “comprises” and “comprise” include each of the stated integers but does not exclude the inclusion of one or more further integers.

In compliance with the statute, the invention has been described in language more or less specific to structural or methodical features. It is to be understood that the invention is not limited to specific features shown or described since the means herein described comprises preferred forms of putting the invention into effect. The invention is, therefore, claimed in any of its forms or modifications within the proper scope of the appended claims appropriately interpreted by those skilled in the art.

1. A container closure engageable with a container having an interior for containing a fluid, the container closure adapted to allow mixing of the fluid and a second material, the container closure comprising
a. a fluid opening through which fluid can flow, the fluid opening in fluid communication with the interior of the container, the fluid opening associated with sealing means adapted to substantially seal the fluid opening in a first position and allow fluid to flow in a second position,
b. a reservoir containing a second material,
c. a first dispenser member associated with the reservoir and having at least one dispenser opening therein, and
d. a second dispenser member respectively formed in relation to the first dispenser member, the second dispenser member movable between a closed position wherein the at least one dispenser opening in the first dispenser member is substantially obstructed so that no second material can flow, and at least one open position
wherein the at least one dispenser opening in the first dispenser member is at least partially unobstructed so that the second material can flow and mix in a passage, prior to exiting the container closure with the fluid flowing through the fluid opening.

2. The container closure according to claim 1 wherein the fluid in the container can access the fluid opening without mixing with the second material.

3. The container closure according to claim 1 wherein the sealing means comprises a plurality of overlapping flexible flaps or petals.

4. The container closure according to claim 3 wherein the petals overlap each other such that in the first closed position, no fluid from the container can pass through the fluid opening.

5. The container closure according to claim 3 wherein the petals are biased into the closed position, and applying a positive pressure to the container by squeezing or inverting the container, forces the petals into the open position and removing that pressure allows them to close again.

6. The container closure according to claim 3 wherein the sealing means includes two action portions, the first action portion positioned above the petals and the second action portion positioned below the petals, both action portions having an opening therein, the openings being coaxial, wherein as the sealing means is raised and lowered, the first and second action portions act to open and close the petals and maintain the petals in the open or closed position as desired by the user.

7. The container closure according to claim 1 wherein the fluid opening is located at one end of an elongate mouthpiece adapted to allow fluid to flow when the mouthpiece is in the raised position and prevent fluid from flowing when the mouthpiece is depressed.

8. The container closure according to claim 7 wherein the mouthpiece is operable between the raised position and the depressed position independently of the operation and the movement of the dispensing portions.

9. The container closure according to claim 1 wherein the first dispenser member is a substantially cylindrical body member having at least one dispenser opening located in a sidewall thereof.

10. The container closure according to claim 9 wherein the first dispenser member has an inner sidewall and an outer sidewall linked at a lower end thereof, both the inner and outer sidewall having dispenser openings therein, and the sealing means is provided with at least one extension portion adapted to extend between the inner sidewall and the outer sidewall of the first dispenser member, such that when the sealing means is in the first position, the extension portion is positioned between the inner sidewall and the outer sidewall of the first dispenser member thereby obstructing or closing the openings therein and preventing the second material from flowing and when the sealing means is in the second position, the extension portion is removed from between the inner sidewall and the outer sidewall of the first dispenser member, thereby allowing the second material to flow.

11. The container closure according to claim 9 wherein the dispenser openings are arrayed in a spiral or helical pattern on the inner and/or outer wall.

12. The container closure according to claim 1 wherein the second dispenser member is located concentrically and coaxially with the first dispenser member.

13. The container closure according to claim 12 wherein the second dispenser member includes a wall with an inside surface and an outside surface, the inside surface of the second dispenser member respectively formed in relation to the first dispenser member to form a sealing wall to seal the dispenser openings of the first dispenser member.

14. The container closure according to claim 12 wherein the second dispenser member comprises a ring portion with a substantially S-shaped cross section, part of the ring portion formed as a sealing wall to seal against the first dispenser member and a bulbous portion, the bulbous portion adapted to seal the reservoir from the first dispenser member when the second dispenser member is in the closed position.

15. The container closure according to claim 1 wherein a plurality of open positions of the second dispenser member and adjusting between the plurality of open positions allows more or less of the second material to flow.

16. The container closure according to claim 15 wherein at least three open positions are provided, the first open position allowing a small amount of second material to mix with the fluid, the second open position allowing proportionally more second material to mix with the fluid, and the third open position allowing the second material to mix with the fluid restrained only by the size of the dispenser openings in the first dispenser member.

17. The container closure according to claim 1 wherein the first dispenser member and the second dispenser member are rotatably movable with respect to each other between the at least one open and the closed position.

18. The container closure according to claim 17 wherein the first dispenser member and the second dispenser member are threadably associated with each other.

19. The container closure according to claim 1 wherein the sealing means and the first and second dispenser members are operable independently of one another to allow a user to access the first fluid without accessing the second material or a mixture of the two.
